(19) United States
(12) Patent Application Publication
(10) Pub. No.: US 2014/0193322 A1
(43) Pub. Date: Jul. 10, 2014

(54) RIGID FOAMS BASED ON PROCYANIDIN- AND/OR PRODELPHINIDIN-TYPE TANNINS AND PREPARATION METHOD THEREOF

(71) Applicants: Alain Celzard, Epinal (FR); Maria-Cecilia Basso, Epinal (FR); Antonio Pizzi, Chantraine (FR); Vanessa Fierro, Epinal (FR)

(72) Inventors: Alain Celzard, Epinal (FR); Maria-Cecilia Basso, Epinal (FR); Antonio Pizzi, Chantraine (FR); Vanessa Fierro, Epinal (FR)

(73) Assignees: CENTRE NATIONAL DE LA RECHERCHE SCIENTIFIQUE, Paris Cedex (FR); UNIVERSITE DE LORRAINE, Nancy Cedex (FR)

(21) Appl. No.: 14/240,724

(22) PCT Filed: Aug. 2, 2012
(86) PCT No.: PCT/FR2012/051828

§ 371 Date: Feb. 24, 2014

(30) Foreign Application Priority Data
Aug. 23, 2011 (FR) 11/02581

(51) Int. Cl. C08G 65/38; C01B 31/08; C08J 9/00

(52) U.S. Cl. CPC C08G 65/38; C08J 9/0033; C08J 9/0023; C01B 31/089
USPC 423/445 R; 521/180; 521/181; 521/121

(57) ABSTRACT

Use of at least one procyanidin- and/or prodelphinidin-type tannin, devoid of prorobinetidin- and/or profisetinidin-type tannin, in a mixture with furfuryl alcohol for the implementation of a polymerization reaction for the preparation of rigid foams, said procyanidin- and/or prodelphinidin-type tannin being in particular pine bark tannin.

The present invention relates to rigid foams based on procyanidin- and/or prodelphinidin-type tannins and the preparation process thereof.

Foams with a thermosetting structure (rigid foams) are very widely used in the context of transport, packaging, protection, insulation, but also in construction materials, automobiles, aeronautical and marine structures, and also in electronic applications and flame retardants.

For all these applications, the performances with respect to fire, fumes and toxicity are critical. From this point of view, the performances of phenolic foams are significantly better than those of polyurethane, polyvinyl chloride or polystyrene foams.

Due to their good insulating properties, their low density, remarkable fire resistance characteristics, their low emission of fumes, the absence of seepage of molten plastic when they are exposed to flames and low cost, phenolic foams provide an appropriate solution for insulation and multilayer materials.

They are also highly resistant to chemical products and solvents.

Finally, due to their brittle character, phenolic foams are capable of irreversibly dissipating energy through the damaging and breaking of the backbone and thus find applications in the field of protection against accidents and packaging.

The foams based on natural products such as foams based on plant tannins, can replace the phenol-formaldehyde foams (i.e. the phenolic resols) in the majority of applications given that they have comparable properties and that plant tannins combine a high reactivity, a “green” origin and a low cost.

Two large families of tannins can be distinguished: the hydrolysable tannins and the condensed tannins or flavonoids.

The condensed tannins are constituted by flavonoid units classified into four entities (Porter, L. J.: The flavonoids. J. B. Harborne, Ed., Chapman and Hall, London, 1988) (FIG. 1):
the prodelphinidin-type tannins having a phloroglucinol-type A ring and a pyrogallol-type B ring (the base element is gallocatechin, FIG. 1A),
the procyanidin-type tannins having a phloroglucinol-type A ring and a catechol-type B ring (the base element is catechin, FIG. 1B)
the prorobinetinidin-type tannins having a resorcinol-type A ring and a pyrogallol-type B ring (the base element is robinetinidol, FIG. 1C),
the profisetinidin-type tannins having a resorcinol-type A ring and a catechol-type B ring (the base element is fisetinidol, FIG. 1D).

The condensed tannin units are generally linked by 4-6 and 4-8 bonds. The condensed tannins have a repetition of 2 to 8 flavonoid units.

These structural differences lead to the very different reactivities of these entities.

Until now, rigid foams based on tannin would be prepared by mixing condensed tannins, furfuryl alcohol, diethyl ether, formaldehyde, in an aqueous medium then the addition of a catalyst, in general paratoluenesulphonic acid (PTSA), after homogenization of the mixture. The addition of the PTSA triggers several reactions such as the condensation of the furfuryl alcohol with the tannin flavonoids, the polymerization of the furfuryl alcohol and the condensation of the tannin flavonoids, which have reacted beforehand with the formaldehyde, on themselves. These three reactions are exothermic and occur simultaneously causing boiling of the diethyl ether which evaporates off at the same time as the reactions take place, which allows the mixture to foam and cross-link at the same time (G. Tondi and A. Pizzi, Industrial Crops and Products, 29, 2009, 356-363).

This process poses several problems the significance of which depends on the desired applications of the foam.

On the one hand, the use of formaldehyde is difficult as it is now recognised as carcinogenic. On the other hand, the presence of residual formaldehyde in the foam can be problematic, particularly in the context of its use as an insulation material for which it is used in large quantities.

Moreover, formaldehyde, which is now classed as toxic and oncogenic by the World Health Organisation and should not be used, or only at a very low concentration, is a reagent which is virtually essential for the preparation of rigid foams but proves to be more difficult to use for the procyanidin-type tannins (in particular pine bark or pecan nut tannin) due to too high a reactivity of these tannins vis-a-vis formaldehyde than for certain types of tannins such as the prorobinetinidin-type tannins (in particular mimosa bark tannin) or profisetinidin-type tannins (in particular quebracho wood tannin).

The too high reactivity of pine bark tannin therefore requires the use of a mixture of mimosa tannin and pine bark tannin in which the pine tannin cannot exceed 40% by weight.

One of the objects of the invention is to provide a process for the preparation of rigid foams in which the procyanidin- or prodelphinidin-type tannin represents 100% of the total weight of tannin, with or without the presence of formaldehyde.

Another object of the invention is to provide rigid foams devoid of the polycondensation products of formaldehyde with procyanidin- and/or prodelphinidin-type tannins and having a greater elasticity as well as a lower apparent density than the foams of the prior art and containing no residual aldehyde.

Another object of the invention is to provide rigid foams comprising the products of polycondensation of formaldehyde with procyanidin- and/or prodelphinidin-type tannins and having a greater elasticity as well as a lower apparent density than the foams of the prior art.

Yet another object of the invention is to provide carbonaceous foams from rigid foams devoid of the polycondensation products of formaldehyde with procyanidin- or prodelphinidin-type tannins.

Yet another object of the invention is to provide carbonaceous foams from rigid foams comprising of the products of polycondensation of formaldehyde with procyanidin- and/or prodelphinidin-type tannins.

The present invention relates to the use of at least one procyanidin- and/or prodelphinidin-type tannin, devoid of prorobinetidin- or profisetinidin-type tannin, in a mixture with furfuryl alcohol for the implementation of a polymerization reaction for the preparation of rigid foams.

Examples of procyanidin-type tannins, without being limited thereto, are the pine tannins, in particular pine bark, pecan nut, gambier (stalk, trunk and leaf), spruce, Douglas fir tannins etc.

Examples of prodelphinidin-type tannins, without being limited thereto, are the Pecan nut tannins.

The procyanidin- and/or prodelphinidin-type tannins are devoid of prorobinetidin- or profisetinidin-type tannin, which means that there is no tannin for example from mimosa or quebracho with said procyanidin- and/or prodelphinidin-type tannins or that they are present in a proportion of less than 0.1%.

The furfuryl alcohol can be of synthetic origin or isolated from plant products such as sawdust, wheat or maize etc.

Unexpectedly, the Inventors have found that the development of the parameters for carrying out the polymerization reactions involved in the preparation of rigid foams would allow the use of procyanidin- and/or prodelphinidin-type tannins without the addition of prorobinetidin- or profisetinidin-type tannin and would lead to rigid foams having physical characteristics better than those of rigid foams of the prior art obtained with mimosa bark tannin or a mixture of mimosa bark and pine bark tannin.

In an advantageous embodiment, the present invention relates to the use of at least one procyanidin- and/or prodelphinidin-type tannin, devoid of prorobinetidin- or profisetinidin-type tannin, in a mixture with furfuryl alcohol for the implementation of a polymerization reaction for the preparation of rigid foams, in which said procyanidin- and/or prodelphinidin-type tannin is pine bark tannin.

The pine bark is advantageously used as the highest proportion of tannin in pine is found in the bark of the latter.

In an advantageous embodiment, the present invention relates to the use of at least one procyanidin- and/or prodelphinidin-type tannin, in particular pine bark tannin, devoid of prorobinetidin- or profisetinidin-type tannin, in a mixture with furfuryl alcohol for the implementation of a polymerization reaction for the preparation of rigid foams, in which said tannin-furfuryl alcohol mixture is devoid of formaldehyde.

By formaldehyde is meant formaldehyde in monomeric form such as liquid formalin, or paraformaldehyde in the form of polyacetal.

Unexpectedly and in contradiction with the prior art which considers formaldehyde as a reagent of choice for the preparation of foams because its reaction with the tannin flavonoids and the polycondensation which follows is a key factor in the formation of the foams, the Inventors have found that the development of the reaction parameters would allow the elimination of said formaldehyde while still making it possible to obtain rigid foams and having in addition physical properties better than those of the prior art.

In an advantageous embodiment, the present invention relates to the use of at least one procyanidin- and/or prodelphinidin-type tannin, in particular pine bark tannin, devoid of prorobinetidin- or profisetinidin-type tannin, in a mixture with furfuryl alcohol for the implementation of a polymerization reaction for the preparation of rigid foams, in which said tannin-furfuryl alcohol mixture comprises formaldehyde.

Also quite unexpectedly and still in contradiction with the prior art which considers that formaldehyde is not appropriate for the preparation of procyanidin- and/or prodelphinidine-type foams as the reaction of formaldehyde with the flavonoids of procyanidin- and/or prodelphinidin-type tannins and the polycondensation which follows is too rapid to cause a sufficient increase in the temperature of the reaction medium and leave time for the foam to develop, the Inventors have found that the development of the reaction parameters would allow the use of procyanidin- and/or prodelphinidin-type tannins with said formaldehyde while still making it possible to obtain rigid foams and having in addition physical properties better than those of the prior art.

In an advantageous embodiment, the formaldehyde can be partially substituted or replaced by glyoxal, hexamine, acetaldehyde, propionaldehyde, butyraldehyde, isobutyraldehyde or furaldehyde.

In an advantageous embodiment, the present invention relates to the use of at least one procyanidin- and/or prodelphinidin-type tannin, in particular pine bark tannin, devoid of prorobinetidin- or profisetinidin-type tannin, in a mixture with furfuryl alcohol for the implementation of a polymerization reaction for the preparation of rigid foams,

in which said tannin-furfuryl alcohol mixture is devoid of formaldehyde, or

in which said tannin-furfuryl alcohol mixture comprises formaldehyde,

comprising moreover a volatile solvent, in particular diethyl ether, a catalyst, in particular paratoluenesulphonic acid, and optionally one or more additives.

The different polycondensation reactions which occur during the preparation of the foam are exothermic and cause the solvent to boil. However, in order for this boiling to be able to occur correctly, it is necessary to use volatile solvents, i.e. with a relatively low boiling point, i.e. comprised from 30° C. to 100° C., in particular from 30° C. to 65° C.

Examples of volatile solvents are, without being limited thereto, diethyl ether, pentane, acetone, petroleum ether.

Advantageously, the solvent is diethyl ether.

The solvent must be volatile as its evaporation with the heat released by the polymerization reactions is responsible for the cellular structure of the foam and particularly allows the foam to swell. The solvent is thus also called a swelling agent.

By the term “catalyst” is meant an organic acid which triggers the different polycondensation reactions.

The organic acid can be, for example without being limited thereto, paratoluenesulphonic acid and phenol sulphonic acid.

Advantageously, the acid is paratoluenesulphonic acid.

The term “additives” denotes different compounds which will act either:

on the structural properties (density and porous texture) and/or on the physical properties (water absorption, resistance to compression of the foam, etc. such as, but without being limited thereto, surfactants, polyurethane, nanoparticles of clay or PEG, or

on the fire resistance, such as but without being limited thereto, boric acid or phosphoric acid or a mixture of the two.

In an advantageous embodiment, the present invention relates to the use of at least one procyanidin- and/or prodelphinidin-type tannin, devoid of prorobinetidin- or profisetinidin-type tannin, in a mixture with furfuryl alcohol for the implementation of a polymerization reaction for the preparation of rigid foams, in which said tannin-furfuryl alcohol mixture is devoid of formaldehyde, as defined above, said reaction comprising the following proportions:
approximately 15% to approximately 66% by weight with respect to the total of the constituents of the mixture, of procyanidin- and/or prodelphinidin-type tannin, in particular pine bark tannin,
more than 0% to at most 21% by weight of an organic acid,
approximately 15% to approximately 60% by weight of furfuryl alcohol,
at least approximately 2% by weight of a volatile solvent, in particular ethyl ether,
optionally up to approximately 10% by weight of a polyether of molecular weight of less than approximately 1000, preferably less than approximately 600, particularly PEG, as additive,
optionally one or more other additives chosen from the surfactants, boric acid or phosphoric acid or a mixture of the two, polyurethane or nanoparticles of clay, in a proportion of approximately 1 to 10% by weight.

It should be noted that except for the water present in the tannins and the different reagents, there is no addition of extra water, unlike the proportions described in the prior art in which approximately 7 to 10% by weight of water is added to the mixture.

PEG is an additive the presence of which makes it possible to dissipate some of the heat of the reaction, which has the effect of changing the swelling speed to curing speed ratios. The main consequence is that the foam can swell more before curing, which leads to a lower density than in the absence of PEG.

In an advantageous embodiment, the present invention relates to the use of at least one procyanidin- and/or prodelphinidin-type tannin, devoid of prorobinetidin- or profisetinidin-type tannin, in a mixture with furfuryl alcohol for the implementation of a polymerization reaction for the preparation of rigid foams, in which said tannin-furfuryl alcohol mixture is devoid of formaldehyde, as defined above, said reaction comprising the following proportions:
approximately 15% to approximately 66% by weight with respect to the total of the constituents of the mixture, of procyanidin- and/or prodelphinidin-type tannin, in particular pine bark tannin,
more than 0% to at most 21% by weight of an organic acid,
approximately 15% to approximately 60% by weight of furfuryl alcohol,
at least approximately 2% by weight of a volatile solvent, in particular ethyl ether,
up to approximately 10% by weight of a polyether of molecular weight of less than approximately 1000, preferably less than approximately 600, particularly PEG, as additive,
optionally one or more other additives chosen from the surfactants, boric acid or phosphoric acid or a mixture of the two, polyurethane or nanoparticles of clay, in a proportion of approximately 1 to 10% by weight.

In an advantageous embodiment, the present invention relates to the use of at least one procyanidin- and/or prodelphinidin-type tannin, devoid of prorobinetidin- or profisetinidin-type tannin, in a mixture with furfuryl alcohol for the implementation of a polymerization reaction for the preparation of rigid foams,

in which said tannin-furfuryl alcohol mixture comprises formaldehyde, as defined above, said reaction comprising the following proportions:
approximately 15% to approximately 66% by weight with respect to the total of the constituents of the mixture, of procyanidin- and/or prodelphinidin-type tannin, in particular pine bark tannin,
more than 0% to at most 21% by weight of an organic acid,
approximately 15% to approximately 60% by weight of furfuryl alcohol,
more than 0% to at most 15% by weight of formaldehyde,
at least approximately 2% by weight of a volatile solvent, in particular ethyl ether,
optionally up to approximately 10% by weight of a polyether of molecular weight of less than approximately 1000, preferably less than approximately 600, particularly PEG,
optionally one or more additives chosen from the surfactants, boric acid or phosphoric acid or a mixture of the two, polyurethane or nanoparticles of clay, in a proportion of approximately 1% to 10% by weight maximum.

It should be noted that except for the water present in the tannins and the different reagents, there is no addition of extra water, unlike the proportions described in the prior art in which approximately 7 to 10% by weight of water is added to the mixture.

The quantity of furfuryl alcohol is to be adjusted as a function of that of the formaldehyde introduced. The smaller the quantity of formaldehyde, the greater the quantity of furfuryl alcohol to be adjusted.

In an advantageous embodiment, the present invention relates to the use of at least one procyanidin- and/or prodelphinidin-type tannin, devoid of prorobinetidin- or profisetinidin-type tannin, in a mixture with furfuryl alcohol for the implementation of a polymerization reaction for the preparation of rigid foams, in which said tannin-furfuryl alcohol mixture is devoid of formaldehyde, as defined above, said reaction comprising the following proportions:
approximately 15% to approximately 66% by weight with respect to the total of the constituents of the mixture, of procyanidin- and/or prodelphinidin-type tannin, in particular pine bark tannin,
more than 0% to at most 21% by weight of an organic acid,
approximately 15% to approximately 60% by weight of furfuryl alcohol,
at least approximately 2% by weight of a volatile solvent, in particular ethyl ether,
up to approximately 10% by weight of a polyether of molecular weight of less than approximately 1000, preferably less than approximately 600, particularly PEG, as additive,
optionally one or more other additives chosen from the surfactants, boric acid or phosphoric acid or a mixture of the two, polyurethane or nanoparticles of clay, in a proportion of approximately 1 to 10% by weight.

The pine tannins have a very high reactivity with formaldehyde under acidic conditions.

The difficulty is therefore to leave the mixture to foam and cure at the same time that the solvent evaporates. The reaction must not start before the temperature is reached which is sufficient for the solvent to play its role as foaming agent.

In this embodiment, said polyether therefore makes it possible:

to lower the exothermicity of the reaction and thus avoid the formation of large bubbles inside the final foam structure,

to reduce the agglomeration of tannin in the mixture which improves the homogeneity of the final foam.

In an advantageous embodiment, said polyether is PEG with a molecular weight of less than approximately 1000, preferably less than approximately 600.

According to another aspect, the present invention relates to a rigid foam comprising at least one procyanidin- and/or prodelphinidin-type tannin, polymerized with furfuryl alcohol and devoid of prorobinetidin- or profisetinidin-type tannin polymerized with furfuryl alcohol.

The flavonoids of procyanidin- and/or prodelphinidin-type tannins polymerize with the furfuryl alcohol in order to produce the following structure I:

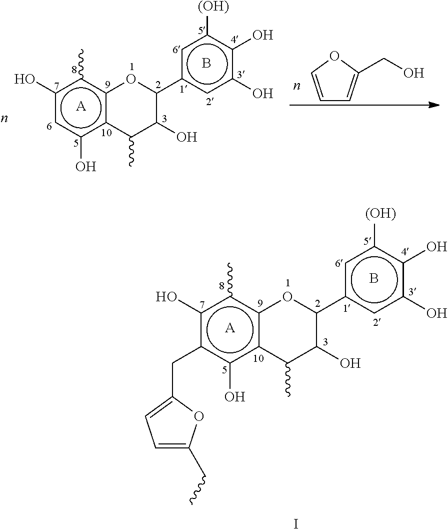

The flavonoids of prorobinetidin- or profisetinidin-type tannins polymerize with the furfuryl alcohol in order to produce the following structure II:

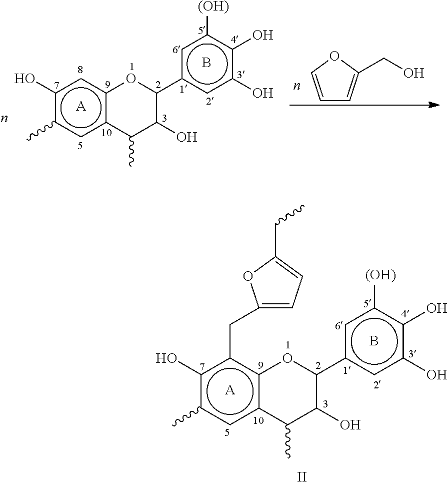

The foams according to the invention are therefore devoid of products of structure II.

In an advantageous embodiment, the present invention relates to a rigid foam comprising at least one procyanidin- and/or prodelphinidin-type tannin, polymerized with furfuryl alcohol and devoid of prorobinetidin- or profisetinidin-type tannin polymerized with furfuryl alcohol, as defined above, in which said tannin is pine bark tannin.

The product of the polymerization of pine bark tannin and furfuryl alcohol therefore corresponds to structure I in which the OH group in position 5′ does not exist and is replaced by an H.

In an advantageous embodiment, the present invention relates to a rigid foam comprising at least one procyanidin- and/or prodelphinidin-type tannin, in particular pine bark tannin, polymerized with furfuryl alcohol and devoid of prorobinetidin- or profisetinidin-type tannin polymerized with furfuryl alcohol, as defined above, and

devoid of products of the polycondensation of formaldehyde with said procyanidin- and/or prodelphinidin-type tannin

When the formaldehyde is present in a reaction medium which comprises a procyanidin- and/or prodelphinidin-type tannin and devoid of prorobinetidin- or profisetinidin-type tannin, it reacts firstly with the procyanidin- and/or prodelphinidin-type tannin in position 6 in order to form the corresponding 6-hydroxymethyl flavonoid.

After the addition of the catalyst, the 6-hydroxymethyl flavonoid reacts with itself in order to form the following product of Formula III:

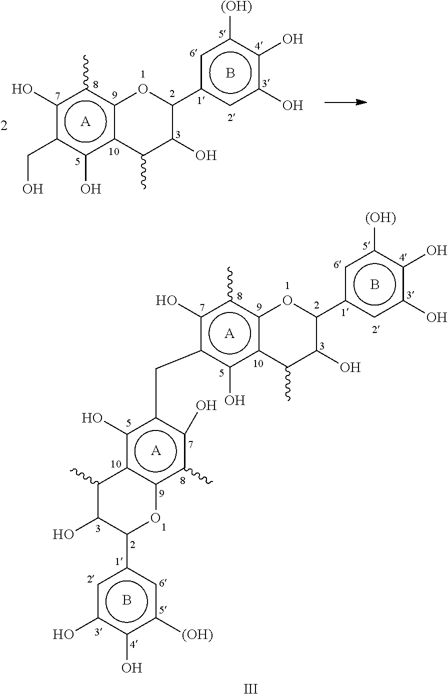

When the formaldehyde is present in a reaction medium which comprises a prorobinetidin- or profisetinidin-type tannin, and is devoid of procyanidin- and/or prodelphinidin-type tannin, it firstly reacts with the prorobinetidin- or profisetinidin-type tannin in position 8 in order to form the corresponding 8-hydroxymethyl flavonoid.

After the addition of the catalyst, the 8-hydroxymethyl flavonoid reacts with itself in order to form the following product of Formula IV:

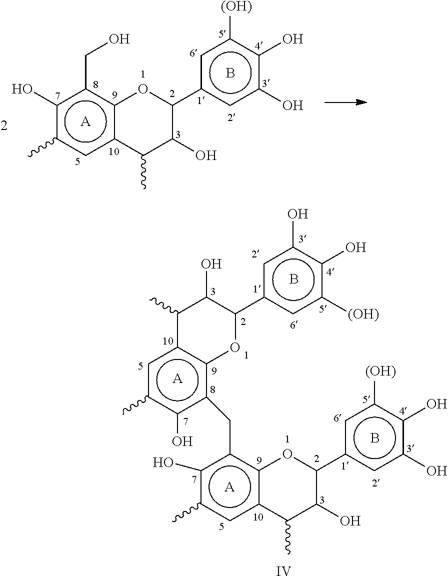

In this embodiment, the formaldehyde is not present and as a result, the foam is devoid both of the product of Formula III and of the product of Formula IV.

One of the advantages of said foam is that it does not contain formaldehyde in the reaction medium, thus avoiding the problems of toxicity of formaldehyde, which is carcinogenic, but it also contains no residual formaldehyde after reaction, which allows various uses of said foam.

In an advantageous embodiment, the present invention relates to a rigid foam comprising at least one procyanidin- and/or prodelphinidin-type tannin, in particular pine bark tannin, polymerized with furfuryl alcohol and devoid of prorobinetidin- or profisetinidin-type tannin polymerized with furfuryl alcohol, devoid of products of the polycondensation of formaldehyde with said procyanidin- and/or prodelphinidin-type tannin and from products of the polycondensation of formaldehyde with said prorobinetidin- or profisetinidin-type tannin, and having an apparent density comprised from 0.01 g/cm³ to 0.16 g/cm³, in particular 0.02 g/cm³ to 0.025 g/cm³ and/or a thermal conductivity comprised from 0.03 W/m/K to 0.05 W/m/K, in particular 0.030 W/m/K and/or a modulus of elasticity comprised from 0.05 MPa to 14 MPa, in particular 0.1 MPa.

The apparent density is defined as the mass of material divided by the total volume that it occupies.

The apparent density is measured by the mass of parallelepipedal samples of known dimensions.

The thermal conductivity represents the insulating capacity of the material. The lower the value, the higher the insulating capacities of the material. The thermal conductivity can be measured by a transitional method by contact such as that called hot disk (Hot Disk TPS 2500, Thermoconcept).

The modulus of elasticity represents the elasticity or the plasticity of a material. The lower the value, the more elastic the material. It can be calculated as indicated in A Celzard et al. (Materials Science and Engineering A, 527, (2010), 4438-4446).

The foam obtained with the process of the invention without formaldehyde has physical characteristics different from those of the prior art and in particular an apparent density which is considerably lower, a higher elasticity which also makes it more attractive for a shock-resistant application and a thermal conductivity which is also lower, which gives it better thermal insulation qualities.

Moreover, they retain their non-flammable nature and particularly the very low self-extinguishing time, of the order of a few seconds and in any case, still very considerably less than a minute.

In an advantageous embodiment, the present invention relates to a rigid foam comprising at least one procyanidin- and/or prodelphinidin-type tannin, in particular pine bark tannin, polymerized with furfuryl alcohol and devoid of prorobinetidin- or profisetinidin-type tannin polymerized with furfuryl alcohol, and

comprising moreover the polycondensation products of formaldehyde with said procyanidin- and/or prodelphinidin-type tannin, and devoid of the polycondensation products of formaldehyde and prorobinetidin- and/or profisetinidin-type tannin.

In this embodiment, said foam is obtained by the process comprising formaldehyde. Said foam therefore comprises products of Formula I, and products of Formula III but is devoid of product of Formula II and products of Formula IV.

Said foam is therefore capable of containing residual formaldehyde after reaction.

In an advantageous embodiment, the present invention relates to a rigid foam comprising at least one procyanidin- and/or prodelphinidin-type tannin, in particular pine bark tannin, polymerized with furfuryl alcohol and devoid of prorobinetidin- or profisetinidin-type tannin polymerized with furfuryl alcohol, as defined above, comprising moreover the polycondensation products of formaldehyde with said procyanidin- and/or prodelphinidin-type tannin, and devoid of polycondensation products of formaldehyde with said prorobinetidin- and/or profisetinidin-type tannin,

having an apparent density comprised from 0.01 g/cm³ to 0.20 g/cm³, particularly from 0.01 g/cm³ to 0.16 g/cm³, in particular 0.07 g/cm³ and/or a thermal conductivity comprised from 0.03 W/m/K to 0.06 W/m/K, particularly from 0.03 W/m/K to 0.05 W/m/K, in particular 0.039 W/m/K and/or a modulus of elasticity comprised from 0.16 MPa to 30 MPa, particularly from 0.16 MPa to 16 MPa, advantageously 2.5, in particular 1.49 MPa.

The foams according to the invention obtained with the process comprising formaldehyde have characteristics slightly different from those obtained without formaldehyde and particularly a slightly higher apparent density, a slightly higher thermal conductivity and a slightly lower elasticity with respect to the foams obtained with the process without formaldehyde.

In an advantageous embodiment, the present invention relates to a rigid foam comprising at least one procyanidin- and/or prodelphinidin-type tannin, in particular pine bark tannin, polymerized with furfuryl alcohol and devoid of prorobinetidin- or profisetinidin-type tannin polymerized with furfuryl alcohol,
devoid of polycondensation products of formaldehyde with said procyanidin- and/or prodelphinidin-type tannin and from polycondensation products of formaldehyde with said prorobinetidin- or profisetinidin-type tannin, as defined above, or
comprising moreover polycondensation products of formaldehyde with said procyanidin- and/or prodelphinidin-type tannin, and devoid of polycondensation products of formaldehyde with said prorobinetidin- and/or profisetinidin-type tannin, as defined above, and
   comprising moreover one or more additives, in particular chosen from the group comprising a surfactant, boric acid, phosphoric acid, PEG and mixtures thereof.

The presence of an additive such as boric acid or phosphoric acid or the mixture of the two makes it possible to reduce the time for self-extinguishing the foams to zero.

In an advantageous embodiment, said additives are present in a proportion of approximately 1 to 10% by weight with respect to the total weight of the constituents of the initial mixture.

In an advantageous embodiment, said additives are a polyether of molecular weight of less than approximately 1000, preferably less than approximately 600, particularly PEG.

According to another aspect, the present invention relates to a carbonaceous foam obtained from a rigid foam comprising at least one procyanidin- and/or prodelphinidin-type tannin, devoid of prorobinetidin- and/or profisetinidin-type tannin, and devoid of polycondensation products of formaldehyde with said procyanidin- and/or prodelphinidin-type tannin and from polycondensation products of formaldehyde with said prorobinetidin- or profisetinidin-type tannin, as defined above,

being able to be obtained by pyrolysis of said rigid foam.

The carbonaceous foams obtained have exactly the same apparent densities as the rigid tannin-based precursor foams. Their thermal conductivity is in the range 0.035-0.12 W/m/K, and their modulus of elasticity is in the range 0.05-55 MPa.

At an equivalent apparent density, there is no significant difference in the properties compared to the carbonaceous foams the precursor of which initially contained formaldehyde.

The carbonaceous foams can be used for the manufacture of activated carbons with dual porosity, catalyst supports, porous electrodes, filters for molten metals and other hot and/or corrosive fluids, shock absorbers or thermal and electromagnetic shields.

According to another aspect, the present invention relates to a carbonaceous foam obtained from a rigid foam comprising at least one procyanidin- and/or prodelphinidin-type tannin, and devoid of prorobinetidin- and/or profisetinidin-type tannin, comprising the polycondensation products of formaldehyde with said procyanidin- and/or prodelphinidin-type tannin and devoid of the polycondensation products of formaldehyde with said prorobinetidin- and/or profisetinidin-type tannin, as defined above,

being able to be obtained by pyrolysis of said rigid foam.

The carbonaceous foams obtained have exactly the same apparent densities as the rigid tannin-based precursor foams. Their thermal conductivity is in the range 0.035-0.12 W/m/K, and their modulus of elasticity is in the range 0.05-55 MPa.

According to another aspect, the present invention relates to a process for the preparation of a rigid foam comprising at least one procyanidin- and/or prodelphinidin-type tannin, polymerized with furfuryl alcohol and devoid of prorobinetidin- or profisetinidin-type tannin, comprising two to five steps of introducing at least one procyanidin- and/or prodelphinidin-type tannin, devoid of prorobinetidin- and/or profisetinidin-type tannin, with furfuryl alcohol.

Unexpectedly, the Inventors have found that the introduction of the tannins in several steps into the reaction medium and over a limited time allows the homogenization of the medium and the obtaining of foams comprising at least one procyanidin- and/or prodelphinidin-type tannin, as well as avoiding the reaction of the tannin with the furfuryl alcohol before swelling occurs.

In an advantageous embodiment, the tannins are introduced in two goes.

In an advantageous embodiment, the tannins are introduced in three goes.

In an advantageous embodiment, the tannins are introduced in four goes.

In an advantageous embodiment, the tannins are introduced in five goes.

In an advantageous embodiment, the present invention relates to a process for the preparation of a rigid foam comprising at least one procyanidin- and/or prodelphinidin-type tannin, polymerized with furfuryl alcohol and devoid of prorobinetidin- or profisetinidin-type tannin polymerized with furfuryl alcohol, and devoid of polycondensation products of formaldehyde with said procyanidin- and/or prodelphinidin-type tannin and from polycondensation products of formaldehyde with said prorobinetidin- or profisetinidin-type tannin, as defined above,

comprising less than 13% water before the start of polymerization.

The water present in the reaction medium, just before the start of polymerization reactions, originates only from that present in the different constituents of the formulation.

Thus the tannins have a moisture content of approximately 9% and the paratoluenesulphonic acid used is at 65% in water.

Unlike the process of the prior art with the prorobinetidin- or profisetinidin-type tannin in which from 7 to 9% water is added to the reaction medium, in the process of the invention without formaldehyde, water is not one of the constituents.

However, in the case in which solid PTSA is used, or is replaced by another organic acid, it would be necessary to introduce the corresponding missing quantity of water into the reaction medium.

In an advantageous embodiment, the present invention relates to a process for the preparation of a rigid foam comprising at least one procyanidin- and/or prodelphinidin-type tannin, polymerized with furfuryl alcohol and devoid of prorobinetidin- or profisetinidin-type tannin polymerized with furfuryl alcohol, and comprising polycondensation products of formaldehyde with said procyanidin- and/or prodelphinidin-type tannin, and devoid of polycondensation products of formaldehyde with said prorobinetidin- and/or profisetinidin-type tannin, as defined above,

comprising at least 22% water before the start of polymerization.

The water present in the reaction medium, just before the start of the polymerization reactions, originates only from that present in the different constituents participating in the reaction.

Thus the tannins have a moisture content of approximately 9%, the paratoluenesulphonic acid used is at 65% in water and the formaldehyde is at 37% in water.

Unlike the process of the prior art with the prorobinetidin- or profisetinidin-type tannin in which 7 to 9% water is added to the reaction medium, in the process of the invention with formaldehyde, water is not one of the constituents.

However, in the case in which solid PTSA is used, or replaced by another organic acid, and/or the aqueous formaldehyde is replaced by another aldehyde, it would be necessary to introduce the corresponding quantity of missing water into the reaction medium.

In an advantageous embodiment, the present invention relates to a process for the preparation of a rigid foam comprising at least one procyanidin- and/or prodelphinidin-type tannin, polymerized with furfuryl alcohol and devoid of prorobinetidin- or profisetinidin-type tannin polymerized with furfuryl alcohol, as defined above,

in which said steps of bringing at least one procyanidin- and/or prodelphinidin-type tannin into contact with furfuryl alcohol are carried out in the presence of a volatile solvent, in particular diethyl ether, and optionally of additives, in a time of less than 30 minutes, preferentially less than 20 minutes and more preferentially less than 10 minutes.

The Inventors have found that the introduction of the tannins must be carried out rapidly, into the mixture in which the catalyst is not yet present, in order to avoid the premature reaction of the furfuryl alcohol with the tannin which is then no longer available to self condense and release the heat necessary for the evaporation of the volatile solvent which leads to foams which do not swell sufficiently.

In an advantageous embodiment, the present invention relates to a process for the preparation of a rigid foam comprising at least one procyanidin- and/or prodelphinidin-type tannin, polymerized with furfuryl alcohol and devoid of prorobinetidin- or profisetinidin-type tannin polymerized with furfuryl alcohol, in which said steps of bringing at least one procyanidin- and/or prodelphinidin-type tannin into contact with furfuryl alcohol are carried out in the presence of a volatile solvent, in particular of diethyl ether, and optionally of additives, in a time of less than 30 minutes, preferentially less than 20 minutes and more preferentially less than 10 minutes, as defined above,

comprising moreover a step of the addition of a catalyst, in particular of paratoluenesulphonic acid.

The addition of the catalyst allows the initiation of the polymerization reactions.

Within a period of 1 to 3 minutes after the addition of the catalyst, the swelling of the structure commences. The energy necessary for the development of the foam is produced by the different reactions.

In an advantageous embodiment, the present invention relates to a process for the preparation of a rigid foam comprising at least one procyanidin- and/or prodelphinidin-type tannin, polymerized with furfuryl alcohol and devoid of prorobinetidin- or profisetinidin-type tannin polymerized with furfuryl alcohol, and devoid of polycondensation products of formaldehyde with said procyanidin- and/or prodelphinidin-type tannin and from polycondensation products of formaldehyde with said prorobinetidin- or profisetinidin-type tannin, as defined above, comprising the following steps:
a. Introduction of a fraction by weight of the total quantity of at least one procyanidin- and/or prodelphinidin-type tannin, devoid of prorobinetidin- and/or profisetinidin-type tannin to be implemented, in particular 1/3, in a mixture comprising furfuryl alcohol, diethyl ether and optionally additives,
b. Stirring the mixture of step a.
c. Introduction of a second fraction by weight equivalent to that of step a. and stirring.
d. Introduction of a third fraction by weight equivalent to that of step a. and stirring.
e. Stirring the mixture comprising the total quantity of tannin, furfuryl alcohol, diethyl ether and optionally additives for a time that ensures the homogeneity of the mixture.
f. The optional addition of other additives to this mixture and stirring until homogenization is complete.
g. Addition to the mixture comprising the total quantity of tannin, of a catalyst, in particular paratoluenesulphonic acid.
h. Stirring the mixture comprising the total quantity of tannin, furfuryl alcohol, diethyl ether, optionally additives and the catalyst at a speed equivalent to that of step c for a time that ensures homogeneity.

In this embodiment, the process is devoid of formaldehyde and except for the water present in the constituents of the formulation, no water is added to the latter.

The tannins are in the form of a powder which is obtained by the spray-drying of a stock solution and which must be optionally refined by grinding in a mortar in the event of agglomeration of the particles. This step does not modify the size of the particles.

The quantity of tannin to be introduced depends on the total number of introduction steps envisaged.

In general, the tannin is divided into equivalent quantities dependent on the number of steps.

Thus for two steps of introduction, the tannin is introduced by halves (by weight).

For three steps, the tannin is introduced by thirds (by weight).

For four steps the tannin is introduced by quarters (by weight).

For five steps, the tannin is introduced by fifths (by weight).

It can however be envisaged that the one or more of the steps of introduction comprise a quantity greater than these proportions since the total introduced remains the same.

The additives optionally added are the same as above.

The speed of stirring in step b. depends on the volume of material to be mixed, the container and the type of screw used.

On a laboratory scale, using one hundred grams, the speed of stirring is 800 rpm.

The speed of stirring in step c. is carried out at a speed greater than that of step b, approximately 1.5 times to twice as rapid, in particular 1.6 times as rapid.

On a laboratory scale, using one hundred grams, the speed of stirring is 1300 rpm.

The speed of stirring in step d. is carried out at a speed greater than that of step c.

On a laboratory scale, using one hundred grams, the speed of stirring is 2000 rpm., approximately 1.4 times to twice as rapid, in particular 1.5 times as rapid.

The speed of stirring in step e. is therefore to be adjusted depending on the total quantity of the formulation, for example so that the complete mixing of tannin, furfuryl alcohol, additives and diethyl ether (steps a to f) before the addition of the catalyst does not exceed one minute on a laboratory scale, which is within the scope of a person skilled in the art.

The term “homogeneity of the mixture” means that the mixture takes the form of a perfectly smooth liquid, without lumps or settling of one or other of the constituents of the formulation.

The time for ensuring the homogeneity in step g. depends on the volume of the reactor, the quantity of formulation introduced and the relative proportions of each constituent in the formulation.

On a laboratory scale, using one hundred grams, the stirring of the mixture is comprised between 5 and 25 seconds, in particular 20 seconds, which is within the scope of a person skilled in the art.

In an advantageous embodiment, the present invention relates to a process for the preparation of a rigid foam comprising at least one procyanidin- and/or prodelphinidin-type tannin, polymerized with furfuryl alcohol and devoid of prorobinetidin- or profisetinidin-type tannin polymerized with furfuryl alcohol, and comprising polycondensation products of formaldehyde with said procyanidin- and/or prodelphinidin-type tannin, and devoid of polycondensation products of formaldehyde with said prorobinetidin- and/or profisetinidin-type tannin, as defined above,

comprising the following steps:
a. Introduction of a fraction by weight of the total quantity of at least one procyanidin- and/or prodelphinidin-type tannin, devoid of prorobinetidin- and/or profisetinidin-type tannin to be implemented, in particular 1/3, in a mixture comprising furfuryl alcohol, diethyl ether, formaldehyde and optionally additives.
b. Stirring the mixture of step a.
c. Introduction of a second fraction by weight equivalent to that of step a. and stirring.
d. Introduction of a third fraction by weight equivalent to that of step a. and stirring.
e. Stirring the mixture comprising the total quantity of tannin, furfuryl alcohol, diethyl ether, formaldehyde and optionally additives for a time that ensures the homogeneity of the mixture.
f. Optional addition of other additives to this mixture and stirring until homogenization is complete.
g. Addition to the mixture comprising the total quantity of tannin of a catalyst, in particular of paratoluenesulphonic acid.
h. Stirring the mixture comprising the total quantity of tannin, furfuryl alcohol, diethyl ether, formaldehyde, optionally additives and the catalyst at a speed equivalent to that of step c. for a time that ensures the homogeneity of the mixture.

In this embodiment, the process comprises formaldehyde and except for the water present in the constituents of the formulation, no water is added to the latter.

The other characteristics are identical to those of the above process without formaldehyde.

According to another aspect, the invention relates to the use of a rigid foam comprising at least one procyanidin- and/or prodelphinidin-type tannin, polymerized with furfuryl alcohol and devoid of prorobinetidin- or profisetinidin-type tannin polymerized with furfuryl alcohol,

and comprising polycondensation products of formaldehyde with said procyanidin- and/or prodelphinidin-type tannin,

or devoid of polycondensation products of formaldehyde with said procyanidin- and/or prodelphinidin-type tannin,

as:

insulation material for buildings, particularly internal insulation,

scavenger of heavy metals in solution, in particular of lead,

shock absorber, in particular in automobiles, or

floral foam.

The invention is illustrated by FIG. 1 and Examples 1 to 4.

### DESCRIPTION OF THE FIGURES

FIGS. 1A to 1B show the four flavonoid entities present in the tannins.

FIG. 1A: prodelphinidin-type tannins having a phloroglucinol-type A ring and a pyrogallol-type B ring (the base element is gallocatechin)

FIG. 1B: procyanidin-type tannins having a phloroglucinol-type A ring and a catechol-type B ring (the base element is catechin).

FIG. 1C: the prorobinetinidin-type tannins having a resorcinol-type A ring and a pyrogallol-type B ring (the base element is robinetinidol).

FIG. 1D: the profisetinidin-type tannins having a ring A of resorcinol type and a catechol-type B ring (the base element is fisetinidol).

FIG. 2 shows the temperature measured with a thermocouple inside the mixture during the growth of the foam (Example 5, diethyl ether (DE)=3 g). The foam formed with the pine tannin with formaldehyde starts to grow as from 2 minutes and the maximum temperature reaches 73.9° C. while the foam based on pine tannin formed without formaldehyde grows from 10 minutes and reaches a maximum at 98.4° C.

The x-axis represents the time in seconds.

The y-axis represents the temperature in ° C.

The left curve (diamonds) corresponds to the pine tannin with formaldehyde.

The right curve (triangles) represents the pine tannin without formaldehyde.

FIG. 3 shows the thermal conductivity of the foams obtained with or without formaldehyde with pine tannin or with mimosa tannin as a function of the density of the foam (Example 5, DE=3 g).

At an apparent density of 0.031 g·cm⁻³, the thermal conductivity reaches 0.033 W/m/K for the pine tannin without formaldehyde (circles) and 0.037 W/m/K for the mimosa tannin with formaldehyde (triangles)

At an apparent density of 0.065 g/cm³, the thermal conductivity is 0.038 W/m/K for the pine tannin with formaldehyde (diamonds).

The foams from pine tannins therefore have a thermal conductivity lower than the foams from mimosa tannin and are therefore better insulating materials than those obtained with mimosa tannins.

x-axis: density (g/cm³)

y-axis: thermal conductivity (W/m/K)

FIG. 4 shows the Young's modulus (modulus of elasticity) as a function of the apparent density expressed on a double logarithmic scale for the foams based on pine tannin or from mimosa using diethyl ether (DE) or pentane (P) (Example 5).

The same behaviour is observed for diethyl ether (white diamonds) or pentane (black diamonds) with pine tannin.

The white triangles represent the result obtained with the mimosa tannin and pentane.

The slope obtained with pine tannin (pentane or diethyl ether) is 3.05, which is double that obtained with mimosa tannin (1.56).

x-axis: log d(g/cm³)

y-axis: log E(kN)

FIG. 5 shows the compressive force as a function of the apparent density expressed on a double logarithmic scale for the foams based on pine or mimosa tannin with or without formaldehyde in the presence of diethyl ether (DE) or pentane (P) (Example 5)

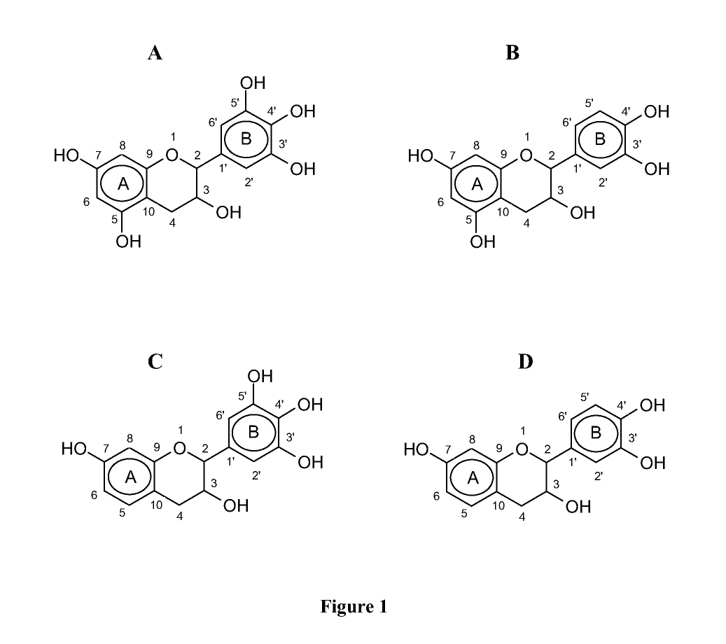

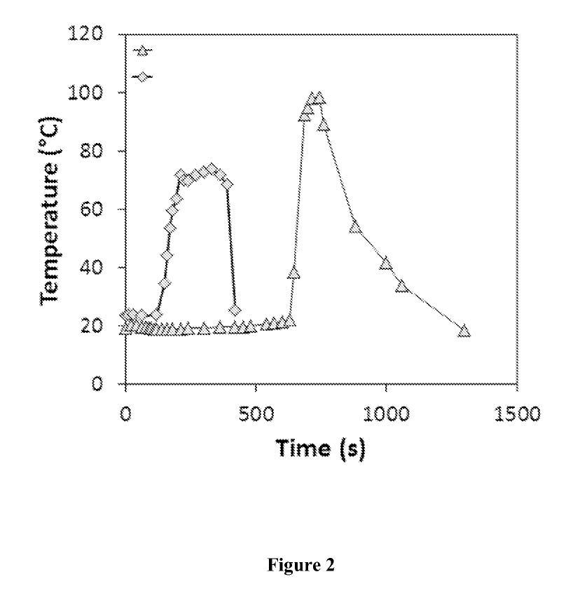

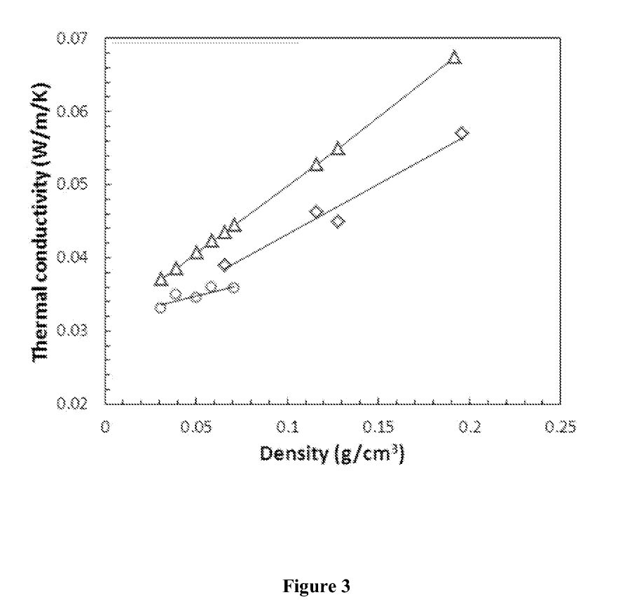

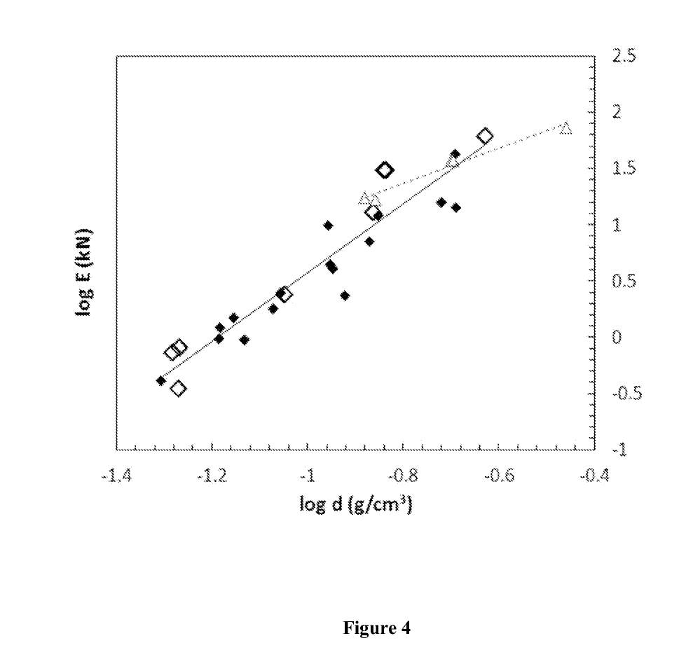

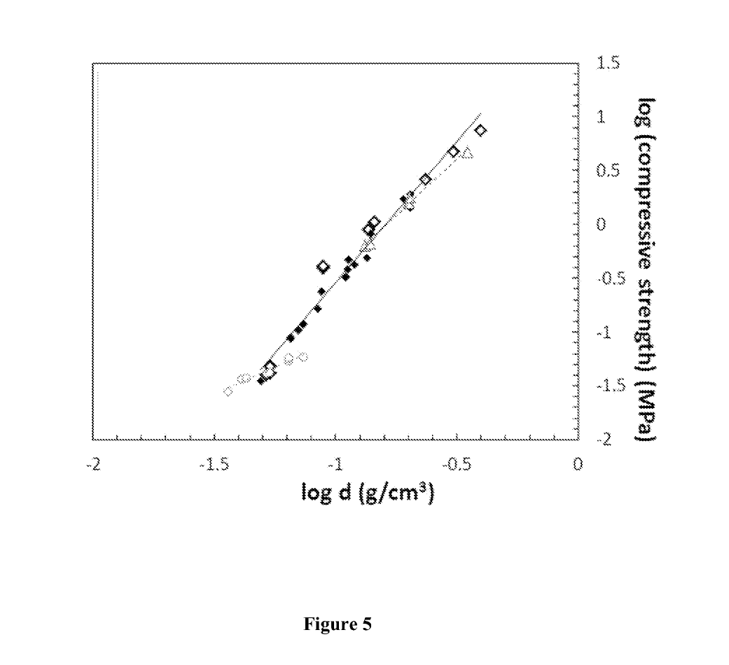

The white diamonds represent the pine tannin with pentane and formaldehyde.

The black diamonds represent the pine tannin with diethyl ether and formaldehyde.

The white triangles represent the mimosa tannin with pentane and formaldehyde.

The white circles represent the pine tannin with diethyl ether without formaldehyde.

The compressive forces obtained with the foams based on pine tannin with diethyl ether or pentane are identical.

The solid line corresponds to the foams based on pine tannin with pentane or diethyl ether with a slope of 2.63 instead of 2.10 for the foams based on mimosa tannin.

x-axis: log d(g/cm³)

y-axis: log (compressive force)(MPa)

### EXAMPLES

### Example 1

### General Procedure for the Preparation of Foams Based on Procyanidin- and/or Prodelphinidin-Type Tannins without Formaldehyde

The procedure presented for pine bark tannin is representative of the other procyanidin- and/or prodelphinidin-type tannins.

The tannins are presented in the form of a powder which is obtained by spray-drying of a stock solution and which should optionally be refined by grinding in a mortar in the event of agglomeration of the particles.

This step does not modify the size of the particles.

The tannins (pine bark tannin, 9% moisture content) are added to the formulation comprising furfuryl alcohol, diethyl ether, and optionally additives, in 3 goes:

1/3 at a stirring speed of 800 rpm, 1/3 at a stirring speed of 1300 rpm and 1/3 at a stirring speed of 2000 rpm.

The addition must be carried out rapidly.

The reaction medium is stirred for 20 seconds at 2000 rpm, before adding the catalyst (PTSA, 65% in H₂O).

The total time that elapses before the introduction of the catalyst must therefore be very much less than 30 minutes in this example on a laboratory scale.

The reaction medium is then stirred for 20 seconds at a speed of less than 2000 rpm as it becomes more liquid.

The reaction medium is then poured into a mould covered by a film of polyethylene or of silicone treated paper, allowing the desired shape to be given to the foam.

Swelling begins after approximately 1 to 3 minutes following the introduction of the catalyst.

### Example 1.1

### Variation of the Quantity of Catalyst

| Formulation | A | B | C | D | E |
|---|---|---|---|---|---|
| Pine bark tannins (g) | 30 | 30 | 30 | 30 | 30 |
| PTSA (g) | 13 | 11 | 10 | 12 | 14 |
| Furfuryl alcohol (g) | 38 | 38 | 38 | 38 | 38 |
| Diethyl ether (g) | 3 | 3 | 3 | 3 | 3 |
| Apparent density (g/cm³) | 0.029 | 0.030 | 0.043 | 0.037 | 0.038 |
| Thermal conductivity | 0.037 | — | — | — | — |
| (W/mK) | | | | | |

The formulations A, B and D give the most homogenous foams. The exothermic processes and the curing:growth kinetics ratio are well controlled.

### Example 1.2

### Variation of the Quantity of Furfuryl Alcohol and/or of the Quantity of Catalyst (PTSA)

| Formulation | F | G | H | I | J |
|---|---|---|---|---|---|
| Pine bark tannins (g) | 30 | 30 | 30 | 30 | 30 |
| PTSA (g) | 11 | 10 | 12 | 10 | 11 |
| Furfuryl alcohol (g) | 33 | 33 | 35 | 35 | 35 |
| Diethyl ether (g) | 3 | 3 | 3 | 3 | 3 |
| Apparent density (g/cm³) | 0.042 | — | 0.032 | 0.029 | 0.029 |

The best foams obtained are those of formulations H-J.

### Example 1.3

### Introduction of an Additive into the Formulation: Example PEG 400

| Formulation | K | L | M | N |
|---|---|---|---|---|
| Pine bark tannins (g) | 30 | 30 | 30 | 30 |
| PTSA (g) | 11 | 11 | 11 | 11 |
| Furfuryl alcohol (g) | 35 | 35 | 35 | 35 |
| PEG400 (g) | 4 | 3 | 2 | 5 |
| Diethyl ether (g) | 3 | 3 | 3 | 3 |
| Apparent density (g/cm³) | 0.023 | 0.021 | 0.025 | 0.0285 |
| Thermal conductivity (W/mK) | — | 0.033 | — | — |

The PEG 400 makes it possible to dissipate a portion of the heat released during the polymerization reactions, and consequently a longer period of time elapses before the foam starts to rise, and the larger the quantity of PEG added, the longer the period of time.

The exothermicity is reduced as a function of the increasing doses of PEG400 introduced.

### Example 1.4

### Introduction of Boric Acid and/or Phosphoric Acid

The formulations are the same as in Examples 1.1, 1.2 and 1.3 with the difference that a few percent (from 1 to 5% by weight) of boric acid and/or phosphoric acid are introduced. The percentage of the other compounds is therefore very slightly reduced (for example the PTSA) so that the total is still 100%.

The presence of boric and/or phosphoric acid as additives in the formulation (therefore at content levels of a few percent by mass) does not result in any significant modifications of the physical properties, but only a fire retardant character which is thereby further improved in relation to the foams which are free thereof.

### Example 2

### Preparation of Carbonaceous Foams from foams without Formaldehyde

A sample of foams of Example 1 is introduced into a quartz tube placed in a horizontal tube furnace. Pyrolysis is carried out by heating at 4° C./min under nitrogen to a final temperature of 900° C. which is maintained for 2 h.

The heating is then stopped and the sample is left to cool to ambient temperature under nitrogen.

Carbonaceous foams of vitreous appearance, black, brittle and shiny are obtained. At an equivalent apparent density, there is no marked difference in the properties compared to those of the carbonaceous foams the precursor of which does not contain formaldehyde.

### Example 3

### General Procedure for the Preparation of Foams Based on Procyanidin- and/or Prodelphinidin-Type Tannins with Formaldehyde

The procedure presented for pine bark tannin is representative of that for the other procyanidin- and/or prodelphinidin-type tannins.

The tannins are presented in the form of a powder which is obtained by spray-drying of a stock solution and which should optionally be refined by grinding in mortar in case of agglomeration of the particles.

This step does not modify the size of the particles.

The tannins (pine bark tannin, 9% moisture content) are added to the formulation comprising furfuryl alcohol, diethyl ether, formaldehyde (37% in H₂O) and optionally additives in 3 goes:

1/3 at a stirring speed of 800 rpm, 1/3 at a stirring speed of 1300 rpm and 1/3 at a stirring speed of 2000 rpm.

The addition must be carried out rapidly.

The reaction medium is stirred for 20 seconds at 2000 rpm, before adding the catalyst (PTSA, 65% in H₂O).

The total time that elapses before the introduction of the catalyst must therefore be very much less than 30 minutes in this example on a laboratory scale.

The reaction medium is then stirred for 20 seconds at a speed of less than 2000 rpm as it becomes more liquid.

If the diameter of the beaker is not too large, the screw of the stirrer must be placed slightly away from the centre, and in order to optimiser the stirring, the vortex must be broken up.

The reaction medium is then poured into a mould covered by a film of polyethylene or of silicone treated paper, allowing the desired shape to be given to the foam.

Swelling begins after approximately 1 to 3 minutes following the introduction of the catalyst.

| Formulation | O |
|---|---|
| Pine bark tannins (g) | 30 |
| PTSA (g) | 11 |
| Formaldehyde (g) | 7.5 |
| Furfuryl alcohol (g) | 19 |
| PEG400 (g) | 4.5 |
| Diethyl ether (g) | 3 |

### Pycnometry of the Formulation O:

Density of the backbone of the foam: 1.41 g/cm³
Density of the backbone after grinding: 1.45 g/cm³
Percentage of open porosity: 97%
Apparent density: 0.103 g/cm³

### Example 4

### Preparation of Carbonaceous Foams from Foams with Formaldehyde

The same protocol as that in Example 2 is used.

At an equivalent apparent density, there is no significant difference in properties compared to the carbonaceous foams the precursor of which initially contains formaldehyde.

### Example 5

### Comparison of the Foams Obtained with Mimosa Tannin or Pine Tannin in the Presence or Absence of Formaldehyde and a Foaming Agent Chosen from Pentane or Diethyl Ether and Comparison with Phenolic Foams

| | | Pine + | Mimosa + |
|---|---|---|---|
| Compound | Pine | Formaldehyde | Formaldehyde |
| Tannins (g) | 30 | 30 | 30 |
| Furfuryl alcohol (g) | 35 | 19 | 10.5 |
| formaldehyde (g) | — | 7.4 | 7.4 |
| Water | — | — | 6 |
| PEG 400 | 3 | 4.5 | — |
| Foaming agent (g) | DE = 0.1 to 3 | DE = 2 to 6 | P = 4 to 6 |
| (Diethyl ether (DE) or | | P = 3 to 6.5 | |
| pentane (P)) | | | |
| Paratoluenesulphonic | 11 | 11 | 11 |
| acid (g) | | | |

| | | | | | Mimosa | |
|---|---|---|---|---|---|---|
| | | Pine tannin | Pine tannin | Mimosa | tannin-based | |
| | Density | without | with | tannin-based | carbonaceous | Phenolic |
| | (g · cm⁻³) | formaldehyde | formaldehyde | foams* | foams* | foams ** |
| Modulus of | 0.035 | 0.18 | — | 1.91 | 3.78 | |
| elasticity | 0.04 | 0.31 | — | 2.47 | 5.79 | |
| (MPa) | 0.05 | 0.29 | 0.41 | 3.79 | 11.82 | |
| | 0.06 | 0.17 | 0.97 | 5.38 | 21.17 | |
| | 0.07 | 0.21 | 1.49 | 6.69 | 27.17 | |
| | 0.11 | — | 7.16 | 12.25 | 55.02 | |
| | 0.14 | — | 20.4 | 16.42 | 75.90 | |
| | 0.19 | — | 26 | 23.37 | 110.71 | |
| Compressive | 0.035 | 0.028 | — | 0.11 | 0.55 | |
| stress (MPa) | 0.04 | 0.034 | — | 0.14 | 0.69 | |
| | 0.05 | 0.041 | 0.06 | 0.20 | 1.00 | 0.76 |
| | 0.06 | 0.042 | 0.09 | 0.27 | 1.37 | |
| | 0.07 | 0.058 | 0.12 | 0.33 | 1.68 | |
| | 0.11 | — | 0.045 | 0.59 | 2.99 | |
| | 0.14 | — | 1.03 | 0.78 | 3.98 | 2.17 |
| | 0.19 | — | 1.75 | 1.10 | 5.61 | |

*A. Celzard et al., (Mechanical properties of tannin-based rigid foams undergoing compression.” Materials Science and Engineering A, 2010; volume 517, No. 16-17, pages 4438-4446
** Shen and Nutt, Mechanical characterisation of short fiber reinforced phenolic foams. Compos., 2003 vol 34, n° 9, pages 899-906); Auad et al., 2007, Flammability properties and mechanical performance of epoxy modified phenolic foams, J. Appl Polym;

The pine tannin-based foams without formaldehyde have a modulus of elasticity of 0.023 MPa on average and no development is observed with the apparent density, which can be due to the fragility of the material which is represented by the compressive force which is low at: 0.028 MPa to 0.058 MPa for densities of 0.035 to 0.07 g/cm³ respectively.

When formaldehyde is added, pine tannin-based foams are more solid and at a low apparent density, their mechanical properties are lower than those obtained with mimosa tannin-based foams. But at a higher apparent density, pine tannin-based foams have better mechanical properties than on mimosa tannin-based foams.

It can therefore be concluded that the pine-tannin based foams have better properties for values of apparent density greater than 0.10 g/cm³ for the Young's modulus and greater than 0.14 g/cm³ for the compressive force respectively.

1. Use of at least one procyanidin- and/or prodelphinidin-type tannin, devoid of prorobinetidin- and/or profisetinidin-type tannin, in a mixture with furfuryl alcohol for the implementation of a polymerization reaction for the preparation of rigid foams, said procyanidin- and/or prodelphinidin-type tannin being in particular pine bark tannin.

2. Use according to claim 1, in which said tannin-furfuryl alcohol mixture is devoid of formaldehyde.

3. Use according to claim 1, in which said tannin-furfuryl alcohol mixture comprises formaldehyde.

4. Use according to one of claims 1 to 3, comprising moreover a volatile solvent, in particular diethyl ether, a catalyst, in particular paratoluenesulphonic acid, and optionally one or more additives.

5. Rigid foam comprising at least one procyanidin- and/or prodelphinidin-type tannin, polymerized with furfuryl alcohol and devoid of prorobinetidin- and/or profisetinidin-type tannin polymerized with furfuryl alcohol, said tannin being in particular pine bark tannin.

6. Rigid foam according to claim 5, devoid of the polycondensation products of formaldehyde with said procyanidin- and/or prodelphinidin-type tannin.

7. Rigid foam according to claim 6, having an apparent density comprised from 0.01 g/cm³ to 0.16 g/cm³, in particular 0.02 g/cm³ to 0.025 g/cm³ and/or a thermal conductivity comprised from 0.03 W/m/K to 0.05 W/m/K, in particular 0.030 W/m/K and/or a modulus of elasticity comprised from 0.05 MPa to 14 MPa, in particular 0.1 MPa.

8. Rigid foam according to claim 5, comprising moreover the polycondensation products of formaldehyde with said procyanidin- and/or prodelphinidin-type tannin and devoid of the polycondensation products of formaldehyde with said prorobinetidin- and/or profisetinidin-type tannin.

9. Rigid foam according to claim 8, having an apparent density comprised from 0.01 g/cm³ to 0.20 g/cm³, particularly from 0.01 g/cm³ to 0.16 g/cm³, in particular 0.07 g/cm³ and/or a thermal conductivity comprised from 0.03 W/m/K to 0.06 W/m/K, particularly from 0.03 W/m/K to 0.05 W/m/K, in particular 0.039 W/m/K and/or a modulus of elasticity comprised from 0.16 MPa to 30 MPa, particularly from 0.16 MPa to 16 MPa, advantageously 2.5, in particular 1.49 MPa.

10. Rigid foam according to one of claims 5 to 9, comprising moreover one or more additives, in particular chosen from the group comprising a surfactant, boric acid, phosphoric acid, PEG and mixtures thereof.

11. Process for the preparation of a rigid foam as defined in claim 5, comprising from two to five steps of introduction of at least one procyanidin- and/or prodelphinidin-type tannin, devoid of prorobinetidin- and/or profisetinidin-type tannin, with furfuryl alcohol.

12. Process for the preparation of a rigid foam according to claim 11, in which said steps of bringing at least one procyanidin- and/or prodelphinidin-type tannin into contact with furfuryl alcohol are carried out in the presence of a volatile solvent, in particular diethyl ether, and optionally of additives, in a time of less than 30 minutes, preferentially less than 20 minutes and more preferentially less than 10 minutes.

13. Process for the preparation of a rigid foam according to claim 11 or 12, comprising moreover a step of the addition of a catalyst, in particular of paratoluenesulphonic acid.

14. Process for the preparation of a rigid foam according to one of claims 11 to 13, comprising the following steps:
a. Contacting a fraction by weight of the total quantity of at least one procyanidin- and/or prodelphinidin-type tannin, devoid of prorobinetidin- and/or profisetinidin-type tannin to be implemented, in particular 1/3, in a mixture comprising furfuryl alcohol, diethyl ether and optionally additives,
b. Stirring the mixture of step a.
c. Introduction of a second fraction by weight equivalent to that of step a. and stirring.
d. Introduction of a third fraction by weight equivalent to that of step a. and stirring.
e. Stirring the mixture comprising the total quantity of tannin, furfuryl alcohol, diethyl ether and optionally additives for a time that ensures the homogeneity of the mixture.
f. The optional addition of other additives to this mixture and stirring until homogenization is complete.
g. Addition to the mixture comprising the total quantity of tannin, of a catalyst, in particular paratoluenesulphonic acid.
h. Stirring the mixture comprising the total quantity of tannin, furfuryl alcohol, diethyl ether, optionally additives and the catalyst at a speed equivalent to that of step c for a time that ensures the homogeneity of the mixture.

15. Process according to one of claims 11 to 13, comprising the following steps:
a. Introduction of a fraction by weight of the total quantity of at least one procyanidin- and/or prodelphinidin-type tannin, devoid of prorobinetidin- and/or profisetinidin-type tannin to be implemented, in particular 1/3, in a mixture comprising furfuryl alcohol, diethyl ether, formaldehyde and optionally additives,
b. Stirring the mixture of step a.
c. Introduction of a second fraction by weight equivalent to that of step a. and stirring.
d. Introduction of a third fraction by weight equivalent to that of step a. and stirring.
e. Stirring the mixture comprising the total quantity of tannin, furfuryl alcohol, diethyl ether, formaldehyde and optionally additives for a time that ensures the homogeneity of the mixture.
f. Optional addition of other additives to this mixture and stirring until homogenization is complete.
g. Addition of a catalyst, in particular paratoluenesulphonic acid, to the mixture comprising the total quantity of tannin.
h. Stirring the mixture comprising the total quantity of tannin, furfuryl alcohol, diethyl ether, formaldehyde, optionally additives and the catalyst at a speed equivalent to that of step c for a time that ensures the homogeneity of the mixture.

16. Carbonaceous foam capable of being obtained by pyrolysis of a rigid foam according to any one of claims 5 to 10.
